(19) United States
(12) Patent Application Publication
(10) Pub. No.: US 2007/0130120 A1
(43) Pub. Date: Jun. 7, 2007

(54) System and method of selectively searching textual content

(76) Inventors: Yen-Fu Chen, Austin, TX (US); John H. Handy-Bosma, Cedar Park, TX (US); Fabian F. Morgan, Austin, TX (US); Keith R. Walker, Austin, TX (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/291,543

(22) Filed: Dec. 1, 2005

(51) Int. Cl. G06F 17/30

(52) U.S. Cl. 707/3

(57) ABSTRACT

The Hyperlinked Document Find Tool (“HDFT”) is a tool for recursively searching textual content of a first file and a hyperlinked file embedded in the first file and stored under the same root directory as the first file. The HDFT selects the first file, enters a search term, searches for the search term in the first file, identifies the hyperlinked file embedded in the first file stored under the same root directory as the first file, and searches for the search term in the hyperlinked file.

### FIELD OF THE INVENTION

The present invention relates generally to data processing and relates specifically to performing textual content searches of a file and all embedded hyperlinks under the root address of the file and the hyperlink.

### BACKGROUND OF THE INVENTION

Search engines make the World Wide Web manageable. Users enter key words into search engines to find the specified content. Once a relevant web site is found, users often need to refine the search for the specific information desired. Some traditional search engines, such as GOOGLE®, allow users to search within a web site using a site restriction option. This site restriction option is useful when a search engine has not indexed a website. A site restriction option has limited usefulness when the website is very large with many internal links, such as online user manuals. The limit to usefulness arises because the search engine searches the entire website and does not allow the user to restrict the search further. Another limit to using a search engine is that the user must use multiple windows or tabs to view both the search results and the specified content.

Most web browsers have a “find” or text search tool that searches within the current document, without the need for a second window or tab. Users enter a target string of characters, then the find tool locates and highlights all occurrences of the string within the document. Find tools search the current page only, not multiple pages within the site.

One known method of selectively searching and indexing multiple documents within a single web site is disclosed in U.S. Pat. No. 6,735,586. The method of the '586 patent allows users to select content from multiple documents as the user surfs though the web site. A custom minimized or “fingerprint” web page is created, and a recursive search can add headings and summaries to the custom page. The user accesses the custom page later to find the desired content. The method of the '586 patent helps users retrace previously located information, but does not aid in the initial search for the desired information.

A need exists for a method to selectively search multiple documents within a web site, without requiring the user to access all related documents in the site. These and other objects of the invention will be apparent to those skilled in the art from the following detailed description of a preferred embodiment of the invention.

### SUMMARY OF THE INVENTION

The invention meeting the need identified above is a Hyperlinked Document Find Tool (HDFT) that allows users to perform keyword searches across selected documents within a web site. The HDFT is activated as a frame, pop-up or toolbar, just as a traditional browser “find” function. The user selects the hyperlinks, or section of text containing hyperlinks to be searched. The HDFT searches the textual content of the selected hyperlinked documents, and recursively searches the content of any hyperlinks embedded in the selected documents. The searched hyperlinks are limited to those documents with the same root address as the initial document.

The HDFT tracks all searched hyperlinks, so as to not repeat a search if the same hyperlinked documents is listed in multiple locations. The listing of searched hyperlinks can also be used to generate a history file of searched pages to allow the user to view the path to the desired content.

The HDFT can be configured to optionally limit the search. For example, the search can be limited to the self, parent and child directories. These limits can be set by means of radio buttons in a preferences tab either prior to performing a search or when initiating a searching.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 represents an exemplary computer network.

FIG. 2 describes programs and files in memory on a computer.

FIG. 3 is a flow chart of the Configuration Component.

FIG. 4 is a flow chart of the Search Component.

FIG. 5 is a flow chart of the User Interface.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perfonn logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Hyperlinked Document Find Tool” or “HDFT”

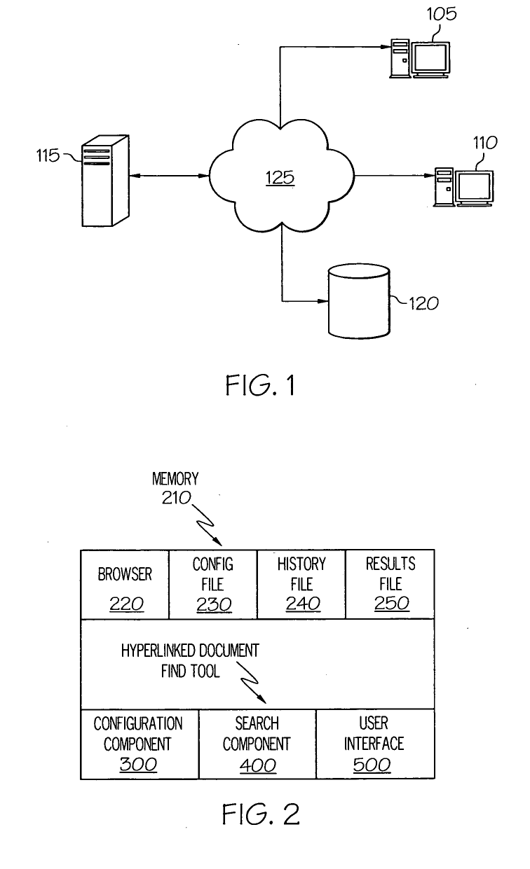

Additionally, the HDFT is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

HDFT 200 typically is stored in a memory, represented schematically as memory 210 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 2 is included merely as a descriptive expedient and does not necessarily reflect any particular physical embodiment of memory 210. As depicted in FIG. 2, though, memory 210 may include additional data and programs. Of particular import to HDFT 200, memory 210 may include Configuration Component 300, Search Component 400 and User Interface 500. Memory 210 may also include the following programs or files with which HDFT 200 interacts: Internet Browser 220, Configuration File 230, History File 240 and Results File 250.

In its preferred embodiment, HDFT 200 runs as a plug-in or extension to Internet Browser 220. HDFT 200 has three main components. Configuration Component 300 allows users to select options related to the display of search results and parameters of the search. Search Component 400 initiates existing text search routines and identifies hyperlinked documents to be searched. User Interface 500 can be a window, frame or toolbar that allows users to enter search parameters and set configuration options. In order to operate, HDFT 200 requires access to Configuration File 230, History File 240 and Results File 250. The use of these components and files is described in further detail below.

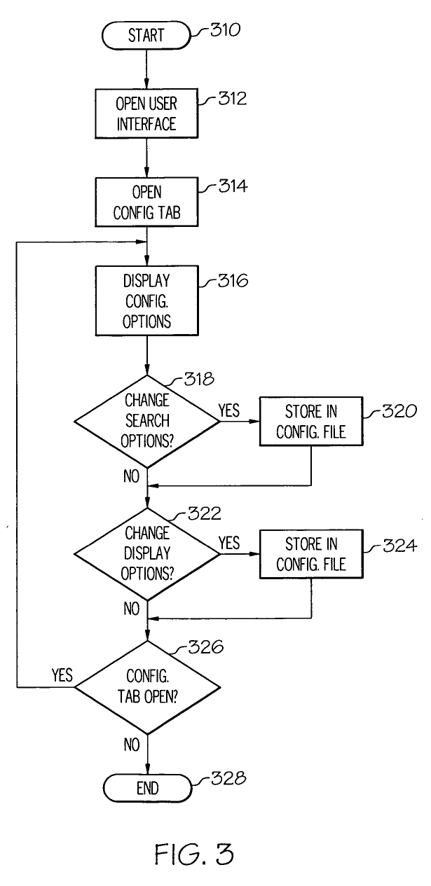

Referring to FIG. 3, Configuration Component 300 starts when activated by the user (310). Configuration Component 300 can be started by selecting an option from a tools menu or from a settings menu in the browser. In either case, the selected option starts User Interface 500 (312). Alternatively, if User Interface 500 is already open, Configuration Component 300 may be started by selecting a configuration tab on User Interface 500 (314). User Interface 500 opens to the configuration tab, listing the configuration options (316). There are two categories of configuration options: search options and display options. If the user elects to change search options (318), the changes are saved in Configuration File 230 (320). Search options allow the user to limit the search, such as only searching hyperlinks in parent and child directories from the first searched document. Other search options could include allowing the user to specify the path of directories to be searched or limiting the search trail length. As used herein, trail length refers to how many jumps or links can be made from the first document. If the user elects to change display options (322), the changes are saved in Configuration File 230 (324). Display options allow the user to control how the search results are displayed. Examples of display options include listing the results in a pop-up window, a drop-down menu or a toolbar. Another option is displaying results in a new browser window or tab. Using a new browser window or tab enables the search history to display in the browser history. Configuration changes can be made as long as the configuration tab remains open (326). Configuration Component 300 stops when the configuration tab is closed (328).

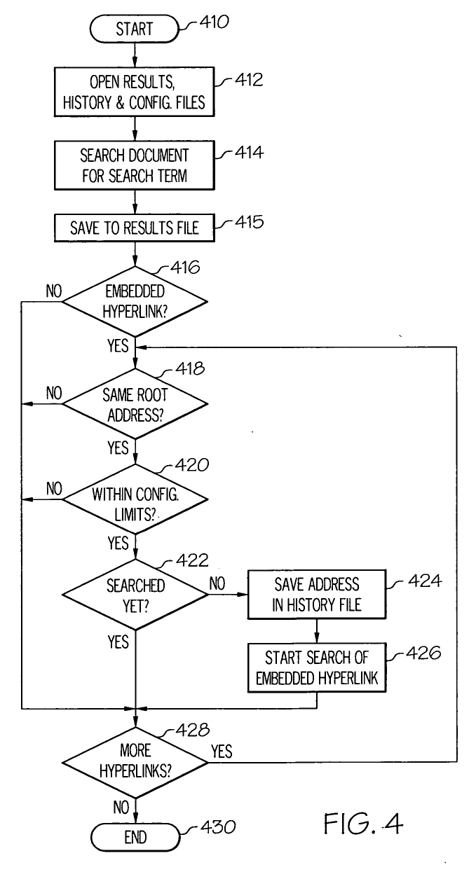

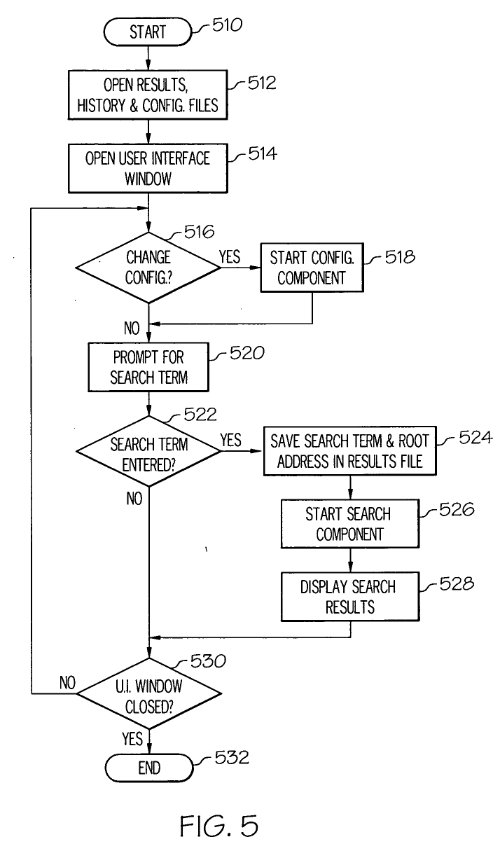

Referring to FIG. 4, Search Component 400 starts whenever a search term is entered at the prompt in User Interface 500 (410). Entering a search term may require the additional step of pressing return or selecting a “start” button on User Interface 500 before actually initiating Search Component 400. Search Component 400 opens Configuration File 230, History File 240 and Results File 250 (412). Search Component 400 initiates a text search for the search term in the current selected page using the native “find” function on Internet Browser 220 (414). Text searches are well known in the art and are not shown here. Results of the text search are saved in Results File 250 (415). In addition to searching for the search term, Search Component 400 also searches for embedded hyperlinks (416). When a hyperlink is found, the search component tests the hyperlink address to determine whether the hyperlink has the same root address as the original document (418). Search Component 400 tests whether the hyperlink is within the configured limits from the configuration file (such as trail length or allowed directory) (420). Search Component 400 then tests whether the hyperlink has already been searched by comparing the hyperlink to those listed in History File 240 (422). If all three tests are met, the search component saves the address of the hyperlink in History File 240 (424), and initiates a new instance of Search Component 400 for the embedded hyperlink (426). The same tests are repeated for every hyperlink in the document (428). Search Component 400 ends when all the hyperlinks have been found and tested (430).

User Interface 500 starts whenever the user initiates HDFT 200 (510). HDFT 200 can be initiated in several ways: In one embodiment, users select “HDFT” from a tools menu or toolbar button. In another embodiment, users right click a mouse pointer of a document, hyperlink or a selected portion of a document containing hyperlinks, and select “HDFT” from a pop-up menu. User Interface 500 opens the results, history and configuration files (512) and opens the User Interface 500 window (514). The User Interface 500 window can be a separate window from Internet Browser 220, a frame within the Internet Browser 220 window or a toolbar on Internet Browser 220. Users may change the settings of the HDFT 200 anytime the User Interface 500 window is open by selecting the settings tab (516) which starts Configuration Component 300 (518). User Interface 500 prompts the user for a search term (520). The search term prompt may also allow the user to specify a URL, a directory, a hyperlink or other document designation. When a search term is entered (522), User Interface 500 saves the search term and the root address of the search document in Results File 250 (524). Search Component 400 is initiated (526), and after the search is complete, the results are displayed as specified in Configuration File 230 (528). Results may be displayed in a pop-up window, a drop-down menu or a toolbar. Results may also be displayed in a new browser window or tab. Using a new browser window or tab enables the search history to display in the browser history. User Interface 500 remains active until the User Interface 500 window closes (530), then User Interface 500 stops (532).

The HDFT may also be applied to search email messages. Web based email services store emails as web pages. Each email is listed on one or more web pages. Each email listing contains a hyperlink to another web page containing the actual email message. The email system may contain a native search function which searches all email messages. The HDFT, however, permits limited searches of the email. The HDFT can search just selected web pages with relevant email listings. The HDFT will follow the hyperlinks of the email listings to search each email. For example, if a user wants to only search emails from a certain chronological period that are listed on pages 10 and 11 of 14 pages, then the HDFT can be configured to only search hyperlinks embedded in pages 10 and 11. Users can also initiate the search on only a selected a group of email message listings on a single web page.

Additionally, the HDFT may be provided with a graphical user interface to integrate the search capabilities of the HDFT with existing search programs having the capability to search files on a system or network. Many files, that are stored on a system or a network, contain hyperlinks or other embedded objects. A search may be conducted through the files in a file folder interface, or an aggregation of different targets of search may be presented. A user can select an initial file or directory to be searched. The HDFT extends the search from the original specified file or directory by searching the embedded hyperlinked files or object.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for recursively searching textual content of a first file and a hyperlinked file embedded in the first file, the process comprising:
selecting the first file;
entering a search term;
searching for the search term in the first file;
identifying the hyperlinked file embedded in the first file; and
searching for the search term in the hyperlinked file.

2. The computer implemented process of claim 1 further comprising displaying the results of the search in an Internet browser.

3. The computer implemented process of claim 1 further comprising storing the URL of all searched hyperlinks in a history file.

4. The computer implemented process of claim 1 further comprising displaying the URL of all searched hyperlinks in a history file of an Internet browser.

5. The computer implemented process of claim 1 further comprising identifying a second hyperlinked file embedded in the first hyperlinked file and searching for the search term in the second hyperlinked file.

6. The computer implemented process of claim 1 wherein the hyperlinked file is searched only if the hyperlinked file is stored under the same root directory as the first file.

7. An apparatus for recursively searching textual content of a first file and a hyperlinked file embedded in the first file, the apparatus comprising:
a processor;
a memory connected to the processor;
a first file with textual content stored in the memory;
a hyperlinked file with textual content stored in the memory;
a hyperlinked document find tool program in the memory operable to cause the processor to search for a search term in the first file, to identify the hyperlinked file embedded in the first file, and to search for a search term in the hyperlinked file.

8. The apparatus of claim 7 further wherein the hyperlinked document find tool program causes the processor to store the URL of all searched hyperlinks in a history file in the memory.

9. The apparatus of claim 7 further comprising an output device connected to the processor and wherein the hyperlinked document find tool program causes the processor to display the search results on the output device.

10. The apparatus of claim 9 further comprising displaying the URL of all searched hyperlinks on the output device.

11. The apparatus of claim 7 wherein the hyperlinked document find tool program causes the processor to identify a second hyperlinked file embedded in the first hyperlinked file and search for the search term in the second hyperlinked file.

12. The apparatus of claim 7 wherein the hyperlinked document find tool program causes the processor to only search the hyperlinked file if the hyperlinked file is stored under the same root directory as the first file.

13. The apparatus of claim 7 wherein the hyperlinked document find tool program further comprises a graphical user interface adapted to integrate with an existing search program for searching files on a system or network.

14. The apparatus of claim 13 wherein the hyperlinked document find tool program extends a user's search from an original specified file by searching an embedded hyperlinked file.

15. A computer readable memory containing a plurality of instructions to cause a computer to recursively search textual content of a first file and a hyperlinked file embedded in the first file, the plurality of instructions comprising:
a first instruction to select the first file;
a second instruction to enter a search term;
a third instruction to search for the search term in the first file;
a fourth instruction to identify the hyperlinked file embedded in the first file; and
a fifth instruction to search for the search term in the hyperlinked file.

16. The computer readable memory of claim 13 wherein the plurality of instructions further comprises: a sixth instruction to display the results of the search in an Internet browser.

17. The computer readable memory of claim 13 wherein the plurality of instructions further comprises: a seventh instruction to store the URL of all searched hyperlinks in a history file.

18. The computer readable memory of claim 13 wherein the plurality of instructions further comprises: an eighth instruction to display the URL of all searched hyperlinks in a history file of an Internet browser.

19. The computer readable memory of claim 13 wherein the plurality of instructions further comprises: a ninth instruction to identify a second hyperlinked file embedded in the first hyperlinked file and a tenth instruction to search for the search term in the second hyperlinked file.

20. The computer readable memory of claim 13 wherein the hyperlinked file is searched only if the hyperlinked file is stored under the same root directory as the first file.
